(19) United States
(12) Patent Application Publication
(10) Pub. No.: US 2016/0185581 A1
(43) Pub. Date: Jun. 30, 2016

(54) Motorized Utility Cart

(71) Applicant: Southworth Products Corporation, Falmouth, ME (US)

(72) Inventors: David Roberts, Standish, ME (US); Mark W. Lilley, Scarborough, ME (US)

(21) Appl. No.: 14/837,890

(22) Filed: Aug. 27, 2015

Related U.S. Application Data
(60) Provisional application No. 62/044,134, filed on Aug. 29, 2014.

(51) Int. Cl. B66F 9/18

(52) U.S. Cl. CPC B66F 9/18

(57) ABSTRACT

A motorized utility cart for a bucket. The cart may include a frame housing and an elevation assembly comprising a first and second vertical member secured to the frame housing. An actuator between the vertical members, a retention hoop connected to a top end of the actuator in a fixed position and to secure a load to a secured position, a carriage member coupled to a movable portion of the actuator adjacent to a front face of the vertical members, and a shelf attached to a carriage member top surface having a fixed portion and a tray portion. The tray portion can be in a shelf position connected at a hinge and configured to be raised in an idle position to accommodate the load. The actuator to facilitate carriage member vertical disposition along a first channel of the vertical members, wherein the channels are vertically aligned with the actuator.

### CROSS-REFERENCE TO RELATED APPLICATIONS

This application claims the benefit of co-pending U.S. Provisional Patent Application Ser. No. 62/044,134, filed on Aug. 29, 2014, which is fully incorporated herein by reference.

### TECHNICAL FIELD

The present disclosure relates to generally to motorized carts and lifting systems, and, in particular, to a motorized utility cart apparatus to facilitate picking up buckets or pails for transport.

### BACKGROUND

Carts or transport devices have been used for carrying buckets or pails. However, many of the carts have numerous disadvantages. For example, the carts themselves are difficult to operate, especially when carrying heavy or multiple items. Further, carts also provide difficulties when carrying items that the cart was not designed to transport. Depending on where the initial location and desired final location of the items may be, such transport may also require manual lifting of the items onto the cart.

### BRIEF DESCRIPTION OF THE DRAWINGS

Reference should be made to the following detailed description which should be read in conjunction with the following figures, wherein like numerals represent like parts:

FIG. 1 illustrates an embodiment of a motorized utility cart consistent with the present disclosure;

FIG. 2 illustrates a internal perspective view of an embodiment of a motorized utility cart consistent with the present disclosure;

FIG. 3 illustrates a top view of an embodiment of a motorized utility cart consistent with the present disclosure;

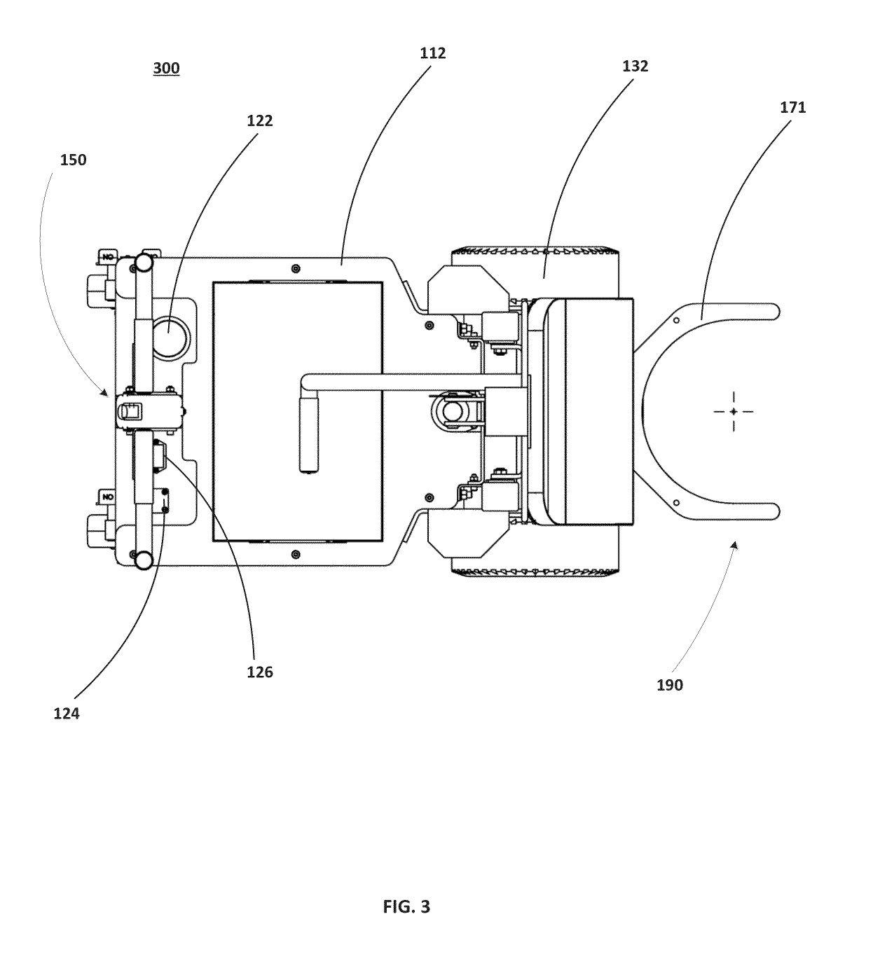

FIG. 4 is an illustration of a side view of an embodiment of a motorized utility cart in an elevated position consistent with the present disclosure.

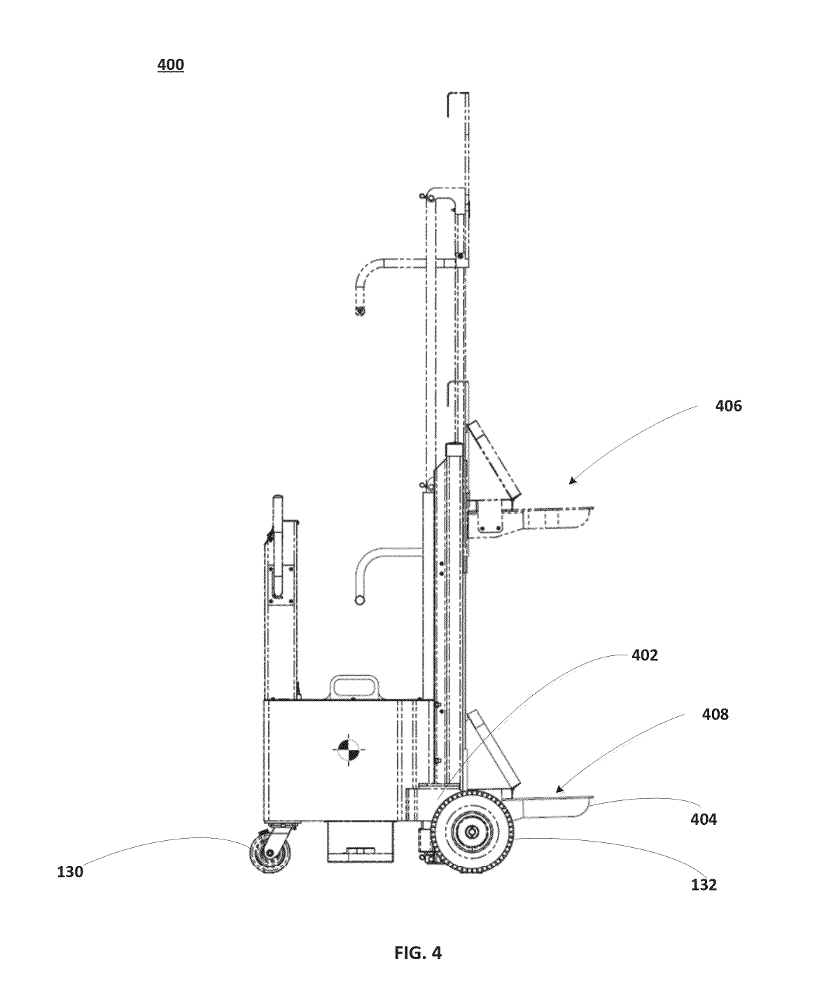

### DETAILED DESCRIPTION

It is to be understood that this disclosure is not limited in its application to the details of construction and the arrangement of components set forth in the following description or illustrated in the drawings. The embodiments herein are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The present disclosure relates to a motorized utility cart apparatus. The motorized utility cart may be configured to facilitate the picking up and transport of an item. For example, the item may be a bucket or a pail or any other cylindrical item that can engage with an engagement member of the utility cart.

The utility cart apparatus may include a frame housing that may include a plurality of surfaces defining a cavity therein, the cavity adapted to enclose components of the utility cart. The frame housing may include an energy source disposed within the cavity. The frame housing may also include a controller assembly configured to allow a user access to control and operate the motorized utility cart. The controller assembly may be disposed within a top surface, or any other accessible surface, of the plurality of surfaces that provides a user access to the controller assembly.

The frame housing may further include a plurality of rear wheels, e.g., two, three, four, etc., mounted on a bottom surface of the plurality of surfaces configured to facilitate mobility and support of the cart assembly. The plurality of wheels may also be configured to allow the movement of the cart apparatus between locations desired by the user.

The utility cart apparatus may also include an elevation assembly mounted to the frame housing. The elevation assembly may be, for example, vertically mounted to a front surface of the frame housing. The front surface of the frame housing may define an opening to permit cables or wires to pass throughout. Alternatively, any of the plurality of surfaces may define at least one opening to permit cable access or any other access to the cavity of the utility cart. The cables or wires may be configured to facilitate communication between components disposed within the cavity and components located outside the cavity.

The elevation assembly may include a first vertical member that is distally opposed from a second vertical member. The vertical members may include a plurality of surfaces wherein a rear surface may be attached at the rear surface to the front surface of the frame housing at a lower end of the vertical members. The vertical members may include a plurality of channels configured to facilitate vertical movement along the channels and up to the top end of the vertical members.

The elevation assembly may also include an actuator disposed between the first and second vertical members. The elevation assembly may further include a movable portion connected to the actuator and the movable portion may be configured to be load bearing. The actuator may operate by any source of energy and may be configured to convert the energy into motion, thereby facilitating the vertical displacement of the movable portion. The movable portion may also be configured to be connected to a member that extends outwardly from the actuator.

The elevation assembly may further include a carriage member that may be coupled to the movable portion of the actuator. The carriage member may be fixed in a cantilevered configuration such that it is connected to the moveable portion of the actuator and be suitable to bear a load during ascending and descending movements. The carriage member may be positioned adjacent to a front face of the first and second vertical members at the lower end of the vertical members.

The carriage member may include a shelf attached to a top surface of the carriage member. The shelf may include a fixed portion, a tray portion and a hinge, wherein the fixed portion is connected to the tray portion at the hinge. The tray portion may be configured to be raised to an idle position and lowered to a shelf position. The idle position is a position such that the tray portion is substantially vertical while still connected at the hinge. The shelf position is a position such that the tray portion is substantially horizontal relative to the fixed portion or within the same plane as the fixed portion. The shelf position may be able to accommodate a load on the tip surface of the tray portion.

The elevation assembly may further include a retention/securing hoop configured to retain or secure a load being carried by the elevation assembly. The retention hoop may be connected or attached to a top end of the actuator and may be situated in a fixed position or in a secured position. The fixed position may be a position such that the retention hoop is substantially vertical relative to the carriage member position or in a position such that it is not in use to secure a load. A secured position may be a position such that the retention hoop is substantially horizontal relative to the carriage member position or in a position such that it is in use by securing or retaining a load, while the load in being transported by a user of the elevation assembly.

The elevation assembly may also further include a plurality of front wheels, e.g., two, three, four, etc., mounted on a bottom surface at a front end of the elevation assembly. The plurality of front wheels may be configured to accommodate a greater load than the plurality of rear wheels.

For example, a five gallon bucket or pail containing paint or some other material, may need to be moved from one location to another location. In this example, the motorized utility cart may be commissioned to access the bucket, engage the bucket by picking it up using the carriage member, transport the bucket via the mobility of the utility cart, and placing the bucket at the desired location by lowering the bucket from the carriage member. The material may be a heavy material that is difficult or cumbersome for a user to transport without assistance. For example, the material may be sand, rocks, stones, nails, or any other dense or fluid material.

In another example, more than one five gallon buckets or pails containing paint or some other material as described for example above herein, may require transport from one location to another desired location. In this example, a user may commission the utility cart to engage with the first bucket by picking it up using the carriage member. The user may then stack multiple buckets on top of the first bucket. The subsequently stacked buckets may be secured by adjusting the retention hoop over or around at least one of the upper stacked buckets, thereby retaining the buckets on the elevation assembly. The user may then safely transport the plurality of buckets or pails to a desired location. Once at the desired location, the utility cart user may lower the buckets to the desired surface and disengage the retention hoop from the upper stacked bucket. The user may then disengage the carriage member from the remaining bucket and leave it at the desired resting place.

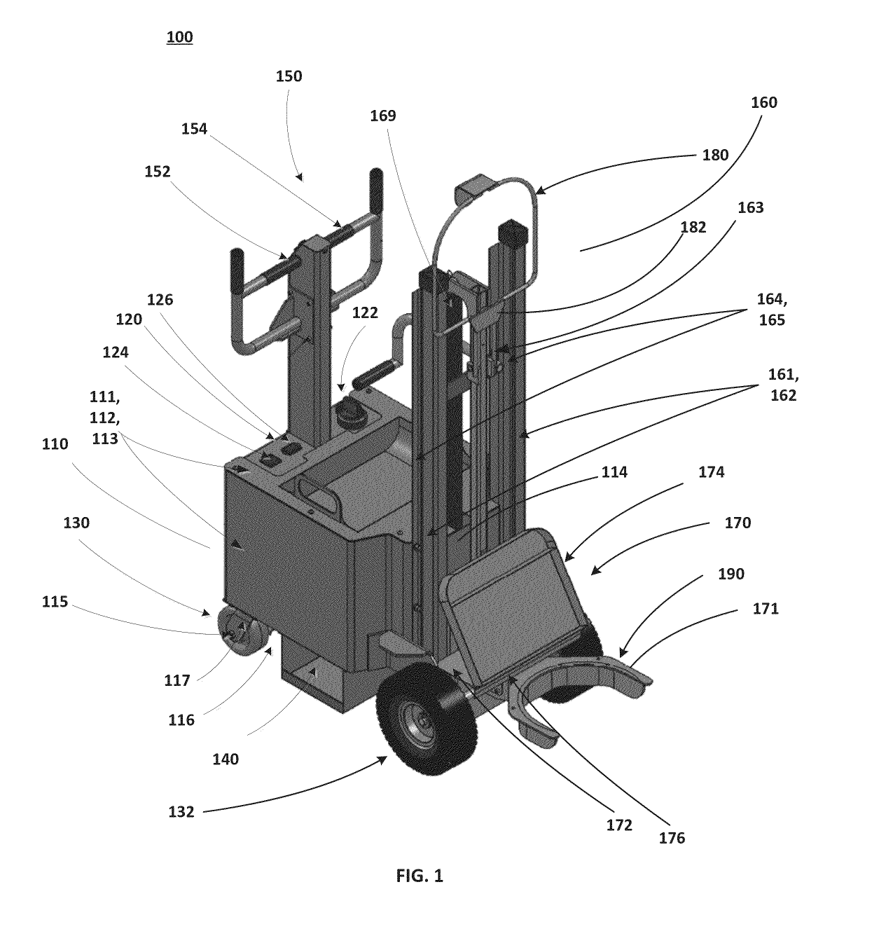

Turning to FIG. 1, there is illustrated a diagram of an exemplary embodiment of a motorized utility cart 100 consistent with the present disclosure. The cart 100 includes a frame housing 110 having a plurality of surfaces 111 defining a cavity therein. The cart 100 also includes an elevation assembly 160 coupled to a front surface 114 of the plurality of surfaces. The elevation assembly 160 may also be coupled to any of the plurality of surfaces 111 such that the elevation assembly is mounted in a vertical direction.

The frame housing 110 may be configured to house and secure components of the cart apparatus 100. The frame housing 110 may be constructed of, for example, metal, wood, glass or any other material suitable and sufficiently rigid for housing components to be used with the cart 100. The frame housing 110 may include a top surface 112 and an adjoining side surface 113 that meet to form a top side and a left side of the frame housing. “Top” and “side”, as used herein, are meant only to differentiate portions of the frame housing 110 and are not meant to limit a position of the cart 100, a position of a user relative to the cart 100, and/or a position of the cart 100 relative to a shelf or desired location.

The frame housing 110 may also include a controller assembly 120 disposed within the top surface 112. The controller assembly 120 may also be disposed within any of the plurality of surfaces 111 such that the controller assembly 120 is accessible to a user. The controller assembly 120 may include a disconnect switch 122, a charger plug harness assembly 124, or a display device 126. The disconnect switch 122 may be configured to turn on or turn off the cart 100 operations. The charger plug harness assembly 124 may be configured to provide access to the charging components of the cart 100. The display device 126 may be configured to display information relating to the cart 100. Although the controller assembly 120 may include the components mentioned herein, the controller assembly 120 may include other components within the scope of the present disclosure.

The frame housing 110 also includes a plurality of rear wheels 130 mounted to a bottom surface 113 of the plurality of surfaces 111. The plurality of rear wheels 130 may be configured to allow the cart 100 to move along a surface. The plurality of rear wheels 130 may also be configured to support the cart 100 and a load that the cart 100 may be transporting. For example, the plurality of rear wheels 130 may be one wheel, two wheels or three wheels and the wheels may be secured to the bottom surface 113 by fasteners 115 connected through a clevis 117. Alternatively, the plurality of rear wheels 130 may be secured to the bottom surface 113 by any other fastening device known to those skilled in the art.

The frame housing 110 may also include a charger port 140 mounted beneath or adjacent to the bottom surface 113 of the frame housing 110. The charger port 140 may be configured to allow access to an electrical assembly 202 of the frame housing 110. For example, the access permitted by the charger port 140 may be electrical access or physical access, such that a user may either connect another device into the charger port 140 or access the frame housing 110 for repairs.

The frame housing 110 may also include a handle portion 150. The handle portion 150 may extend vertically from the top surface 112 and disposed at a rear end of the top surface 112. The handle portion 150 may be configured to facilitate movement of the cart 100. For example, the handle portion 150 may facilitate movement of the cart 100 by allowing a user to apply a force to the handle portion 150 such that the force transfers to the cart 100 to result in movement in a direction corresponding to the direction of the force. The handle portion 150 may include handle grips 152, 154 configured to provide a secure grip to the handle portion 150. The handle portion 150 may also be configured in a U-shape, as illustrated in FIG. 1. Although the handle portion 150 is illustrated in a U-shape, it should be understood that the handle portion 150 may be in other shapes suitable for use as described in the present disclosure.

The elevation assembly 160 may be configured to secure an item, lift up the item, hold the item during transport, and put down the item. The item to be secured by the elevation assembly 160 may also be a plurality of items. For example, the elevation assembly 160 may be configured to pick up a bucket or a pail and secure the bucket or pail during transport. The elevation assembly 160 may be mounted, either vertically or otherwise in a secured position, to a front surface 114 of one of the plurality of surfaces 111.

The elevation assembly 160 may include a first vertical member 161 distally opposed from a second vertical member 162. Each of the vertical members may include a lower end and an upper end, wherein the lower end may be secured to the front surface 114 of the frame housing 110. The vertical members 161, 162 may also include channels 164, 165 along the vertical length of the vertical members 161, 162. The channels 164, 165 may be vertically aligned with the elevation assembly 160. The vertical members 161, 162 may be constructed from, for example, steel, iron, or any other rigid material suited for use consistent with the present disclosure.

The elevation assembly 160 may also include an actuator 169 disposed between the vertical members 161, 162 and vertically aligned with the elevation assembly 160. The elevation assembly 160 may further include a movable portion 402 connected to the actuator 169 and the movable portion 402 may be configured to be load bearing. The actuator 169 may operate by any source of energy and may be configured to convert the energy into motion, thereby facilitating the vertical displacement of the movable portion 402. The movable portion 402 may also be configured to be connected to a support member 404 that extends outwardly from the actuator 169.

The elevation assembly 160 may also include a retention hoop 180 connected to a top end of the actuator. The retention hoop 180 may be situated in a fixed position 182 configured to secure a load by being lowered to a secured position. The fixed position 182 may be a position such that the retention hoop 180 is substantially vertical relative to the carriage member position or in a position such that it is not in use to secure a load. The secured position may be a position such that the retention hoop 180 is substantially horizontal relative to the carriage member position or in a position such that it is in use by securing or retaining a load, while the load in being transported by a user of the elevation assembly 160 of the cart 100.

The elevation assembly 160 may also include a plurality of front wheels 132, e.g., one, two, three, four, etc., mounted on a bottom surface 116 at a front end of the elevation assembly 160. The plurality of front wheels 132 may be configured to accommodate a greater load than the plurality of rear wheels 130.

The elevation assembly 160 may further include a carriage member 190 that may be coupled to the movable portion 402 of the actuator 169. The carriage member 190 may be fixed in a cantilevered configuration such that it is connected to the moveable portion 402 of the actuator 169 and be suitable to bear a load during ascending and descending movements. The carriage member 190 may be positioned adjacent to a front face of the first and second vertical members 161, 162 at the lower end of the vertical members.

The elevation assembly 160 may also include a shelf 170 attached to a carriage member top surface 171. The shelf 170 may include a fixed portion 172 and a tray portion 174 connected at a hinge 176. The tray portion 174 may be configured to be raised in an idle position 404 and to be lowered to a shelf position 406 to accommodate the load. The actuator 169 may be configured to facilitate vertical disposition of the carriage member 190 along the channels 164, 165 corresponding to the vertical members 161, 162.

The plurality of wheels 130, 132 may be, for example, Albion 04 Series 5″ Diameter X-tra Soft Rubber Flat Tread Wheel Light Duty Stainless Steel Plate Rigid Caster, Delrin Bearing, 3⅝″ Length×2½″ Width Plate, 325 lbs Capacity (Pack of 4) Greenlee 603 6″ Caster Set, Two Rigid and Two Swivel.

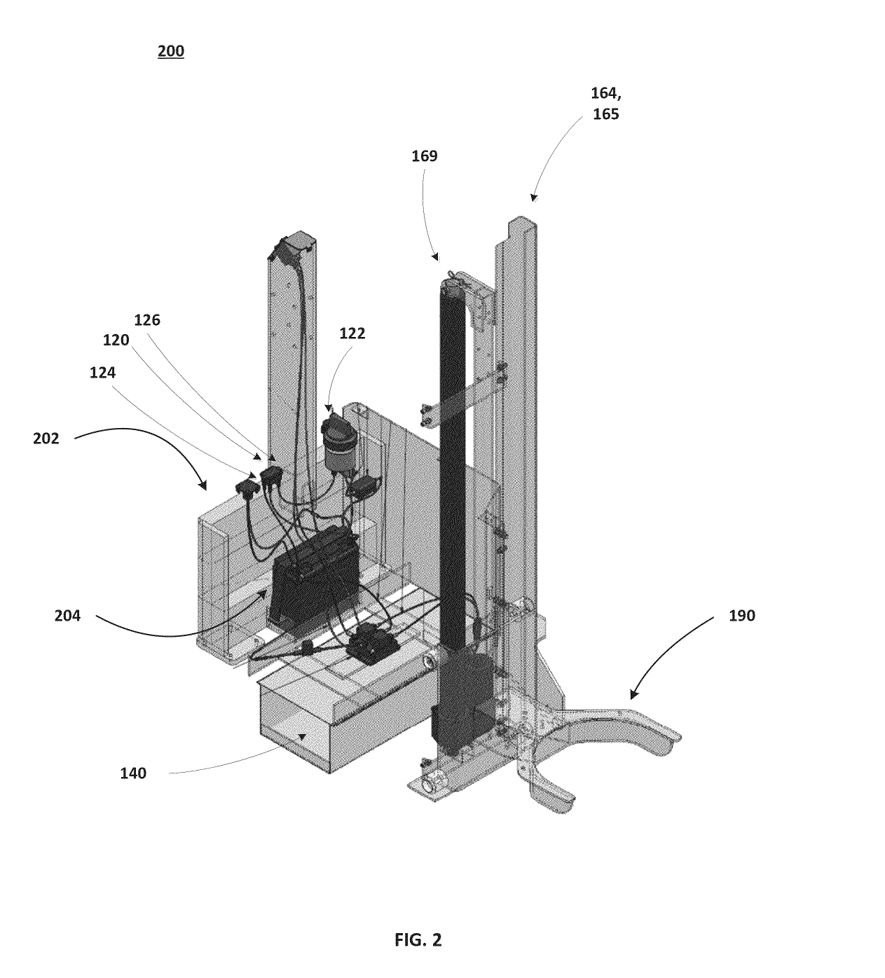

Turning to FIG. 2, there is illustrated an internal perspective view of an exemplary embodiment of a motorized utility cart 100 consistent with the present disclosure. The cart 100 includes the electrical assembly 202, including the energy source 204. The energy source 204 may be a battery or any other energy source suitable for the purposes of the operation of the cart 100 as described in the present disclosure.

The embodiments that have been described herein, however, are but some of the several which utilize this invention and are set forth here by way of illustration but not of limitation. Many other embodiments, which will be readily apparent to those skilled in the art, may be made without departing materially from the spirit and scope of the invention as defined in the appended claims.

What is claimed is:

1. A motorized utility cart comprising:
a frame housing having a plurality of surfaces defining a cavity therein, the frame housing comprising:
an energy source disposed within the cavity,
a controller assembly mounted on a top surface of the plurality of surfaces,
a plurality of rear wheels mounted on a bottom surface of the plurality of surfaces,
a charger port mounted beneath the bottom surface,
a handle portion extending vertically from the top surface and disposed at a rear end of the top surface, wherein the controller assembly and the handle portion are configured to facilitate movement of the cart; and
an elevation assembly vertically mounted to a front surface of the plurality of surfaces, the elevation assembly comprising:
a first vertical member distally opposed from a second vertical member and each of the vertical members having a lower end secured to the front surface of the frame housing,
an actuator disposed between the vertical members,
a retention hoop connected to a top end of the actuator situated in a fixed position and configured to secure a load by being lowered to a secured position,
a plurality of front wheels mounted on a bottom surface of the elevation assembly,
a carriage member coupled to a movable portion of the actuator adjacent to a front face of the first and second vertical members at the lower end of the vertical members, and a shelf attached to a carriage member top surface, the shelf having a fixed portion and a tray portion connected at a hinge, the tray portion configured to be raised in an idle position and to be lowered to a shelf position to accommodate the load.

2. A motorized utility cart comprising:
a frame housing; and
an elevation assembly vertically mounted to a front surface of the plurality of surfaces, the elevation assembly comprising:
a first vertical member distally opposed from a second vertical member and each of the vertical members having a lower end secured to the front surface of the frame housing,
an actuator disposed between the first and second vertical members,
a retention hoop connected to a top end of the actuator situated in a fixed position and configured to secure a load by being lowered to a secured position,
a carriage member coupled to a movable portion of the actuator adjacent to a front face of the first and second vertical members at the lower end of the vertical members, and
a shelf attached to a carriage member top surface, the shelf having a fixed portion and a tray portion connected at a hinge, the tray portion configured to be raised in an idle position and to be lowered to a shelf position to accommodate the load, wherein the actuator is configured to facilitate vertical disposition of the carriage member via the movable portion traveling along a first channel corresponding to the first vertical member and along a second channel along the second vertical member, wherein the plurality of channels are vertically aligned with the actuator.
